(19) United States
(12) Patent Application Publication
(10) Pub. No.: US 2026/0228214 A1
(43) Pub. Date: Aug. 6, 2026

(54) EVALUATING GENERATIVE ARTIFICIAL INTELLIGENCE OUTPUT USING DIVERSE SYSTEMS

(71) Applicant: International Business Machines Corporation, Armonk, NY (US)

(72) Inventors: Nixon CHEAZ, Cary, NC (US); Christopher Thomas LEONARD, Round Rock, TX (US)

(21) Appl. No.: 19/046,847

(22) Filed: Feb. 6, 2025

(51) Int. Cl. G06F 16/2452; G06F 16/215

(52) U.S. Cl. CPC G06F 16/2452; G06F 16/215

(57) ABSTRACT

In some implementations, a device may receive a user prompt and an output generated by a generative artificial intelligence (AI) system based on the user prompt. The device may provide the output to a panel of diverse large language models (LLMs) for evaluation. The device may receive a score from each LLM of the panel, the score indicating a degree of propriety of an ethical issue in the output. The device may rewrite the prompt based on the scores and the output to generate a rewritten prompt. The device may output the rewritten prompt to the generative AI system.

### BACKGROUND

This disclosure relates to generative artificial intelligence (AI), and more specifically, to prompts for generative AI.

### SUMMARY

In some implementations, a computer-implemented method includes receiving, by a processor set, a user prompt and an output generated by a generative AI system based on the user prompt. The computer-implemented method includes providing, by the processor set, the output to a panel of diverse large language models (LLMs) for evaluation. The computer-implemented method includes receiving, by the processor set, a score from each LLM of the panel of diverse LLMs, the score indicating a degree of propriety of an ethical issue in the output. The computer-implemented method includes rewriting, by the processor set, the prompt based on the scores and the output to generate a rewritten prompt. The computer-implemented method includes outputting, by the processor set, the rewritten prompt to the generative AI system.

In some implementations, a computer system includes a processor set, one or more computer-readable storage media, and program instructions stored on the one or more computer-readable storage media to cause the processor set to perform operations. The operations comprise receiving a user prompt and an output from a generative AI system based on the user prompt. The operations comprise providing the user prompt and the output to a panel of diverse LLMs for evaluation. The operations comprise receiving a propriety score from each LLM of the panel of diverse LLMs, where the propriety scores are weighted differently for each LLM.

The operations comprise rewriting the prompt to generate a rewritten prompt based on a result of a comparison of the propriety scores to an issue impropriety threshold. The operations comprise outputting the rewritten prompt to the generative AI system.

In some implementations, a computer program product includes one or more computer-readable storage media and program instructions stored on the one or more computer-readable storage media to perform operations. The operations comprise evaluating, by a panel of diverse LLMs, an output from a generative AI system to assess ethics of the output, the output being based on a user prompt. The operations comprise providing, by each LLM of the panel of diverse LLMs, a score indicating a degree of propriety of an ethical issue detected in the output. The operations comprise determining whether the output exceeds an ethics impropriety threshold for ethical acceptability based on the scores from the panel of diverse LLMs.

### BRIEF DESCRIPTION OF THE DRAWINGS

FIG. 1 is a diagram of an example computing environment for evaluating generative AI output using a diverse system described herein.

FIG. 2 is a diagram illustrating an example of evaluating and mitigating improper output in generative AI.

FIG. 3 is a flowchart of an example process associated with evaluating generative AI output using diverse systems.

FIG. 4 is a flowchart of an example process associated with evaluating generative AI output using diverse LLMs.

FIG. 5 is a flowchart of an example process associated with evaluating generative AI output using diverse LLMs.

### DETAILED DESCRIPTION

The following detailed description of example implementations refers to the accompanying drawings. The same reference numbers in different drawings may identify the same or similar elements.

According to an aspect, there is provided a computer-implemented method that includes receiving, by a processor set, a user prompt and an output generated by a generative AI system based on the user prompt. The computer-implemented method may include providing, by the processor set, the output to a panel of diverse LLMs for evaluation, and receiving, by the processor set, a score from each LLM of the panel of diverse LLMs. The score indicates a degree of propriety of an ethical issue in the output. The computer-implemented method may include rewriting, by the processor set, the prompt based on the scores and the output to generate a rewritten prompt and outputting, by the processor set, the rewritten prompt to the generative AI system. In this way, the computer-implemented method reduces computational overhead associated with manual review and editing of generated outputs, and improves the efficiency of AI output evaluation. The computer-implemented method may conserve processing resources, memory resources, and/or network resources by minimizing the number of iterations required to generate compliant output, reducing the need for manual intervention, and streamlining the output evaluation process. Additionally, the computer-implemented method may optimize the use of LLMs by distributing the evaluation workload across multiple models, thereby reducing the computational load on individual models and improving overall system scalability.

By having multiple LLMs with different perspectives, the system can identify and have a better chance of catching improper generative AI. The system may then address potential issues more quickly, reducing the number of iterations required to generate an acceptable output. The diversity of the LLMs can help the system converge on a solution more quickly, reducing the computational resources required to generate an acceptable output. Each LLM may have its own strengths and weaknesses, and by using a diverse panel, the system can be sure to have suitable LLMs evaluate the output. All of this can conserve processing resources, memory, and network bandwidth.

In one or more embodiments, the generative AI system and each LLM of the panel of diverse LLMs are associated with a different vendor and architecture. This further ensures the diversity of the LLMs. The increased diversity further limits bias in the evaluation, which further conserves processing resources, memory resources, and/or network resources by further minimizing the number of iterations required to generate compliant output.

In one or more embodiments, the LLMs of the panel of diverse LLMs are trained on different datasets. This further ensures the diversity of the LLMs. The increased diversity further limits bias in the evaluation, which further conserves processing resources, memory resources, and/or network resources by further minimizing the number of iterations required to generate compliant output.

In one or more embodiments, each LLM of the panel of diverse LLMs is trained specifically to evaluate ethics of a generative AI output. In this way, processing resources are conserved by not training the panel for other tasks.

In one or more embodiments, the panel of diverse LLMs is isolated from the generative AI system to prevent bias. This further ensures the diversity of the LLMs. The increased diversity further limits bias in the evaluation, which further conserves processing resources, memory resources, and/or network resources by further minimizing the number of iterations required to generate compliant output.

In one or more embodiments, the score from each LLM of the panel of diverse LLMs is weighted based on one or more LLM factors. This weights some LLMs more than others, according to factors such as historical accuracy. This further limits bias in the evaluation, which further conserves processing resources, memory resources, and/or network resources by further minimizing the number of iterations required to generate compliant output.

In one or more embodiments, the rewriting of the prompt comprises rewriting the prompt to avoid the ethical issue. In one or more embodiments, the rewriting of the prompt includes rewriting the prompt a plurality of times until the degree of propriety is met or a threshold is reached. In this way, processing resources are conserved by not continuing the process beyond what is necessary.

In one or more embodiments, the panel of diverse LLMs provides a summary of the ethical issue. In one or more embodiments, the rewriting of the prompt includes rewriting the prompt based on the summary of the ethical issue. In this way, processing resources are conserved by reducing the number of iterations by informing the nature of the rewrites.

In one or more embodiments, the method includes receiving a new output from the generative AI system based on the rewritten prompt, providing the new output to the panel of diverse LLMs for evaluation, and receiving a new score from each LLM in the panel of diverse LLMs, the new score indicating whether there is an ethical issue in the new output.

According to an aspect, a computer system includes a processor set, one or more computer-readable storage media, and program instructions stored on the one or more computer-readable storage media to cause the processor set to perform operations. The operations comprise receiving a user prompt and an output from a generative AI system based on the user prompt, and providing the prompt and the output to a panel of diverse LLMs for evaluation. The operations comprise receiving a propriety score from each LLM of the panel of diverse LLMs, where the propriety scores are weighted differently for each LLM, and rewriting the prompt to generate a rewritten prompt based on a result of a comparison of the propriety scores to an issue impropriety threshold. Weights may be provided to give some evaluator LLMs more emphasis or voting power than other evaluator LLMs to conform the panel to a particular range or to prune the panel's evaluation. The operations comprise outputting the rewritten prompt to the generative AI system. In this way, the computer system reduces computational overhead associated with manual review and editing of generated outputs, and improves the efficiency of AI output evaluation. The computer system may conserve processing resources, memory resources, and/or network resources by minimizing the number of iterations required to generate compliant output, reducing the need for manual intervention, and streamlining the output evaluation process. Additionally, the computer system may optimize the use of LLMs by distributing the evaluation workload across multiple models, thereby reducing the computational load on individual models and improving overall system scalability.

By having multiple LLMs with different perspectives, the system can identify and address potential issues more quickly, reducing the number of iterations required to generate an acceptable output. The diversity of the LLMs can help the system converge on a solution more quickly, reducing the computational resources required to generate an acceptable output. Each LLM may have its own strengths and weaknesses, and by using a diverse panel, the system can be sure to have suitable LLMs evaluate the output. All of this can conserve processing resources, memory, and network bandwidth.

In one or more embodiments, the issue impropriety threshold is an ethics impropriety threshold. In one or more embodiments, the issue impropriety threshold is a legal impropriety threshold. In one or more embodiments, the issue impropriety threshold is a religious impropriety threshold.

In one or more embodiments, the panel of diverse LLMs includes LLMs from different vendors and that have different architectures and training datasets. The increased diversity further limits bias in the evaluation, which further conserves processing resources, memory resources, and/or network resources by further minimizing the number of iterations required to generate compliant output.

In one or more embodiments, the operations comprise performing the rewriting recursively until the issue impropriety threshold is met or a maximum number of attempts is reached. In one or more embodiments, the operations comprise reporting that proper output cannot be generated based on the maximum number of rewrite attempts having been reached. In this way, processing resources are conserved by reducing the number of iterations by informing the nature of the rewrites.

According to an aspect, a computer program product includes one or more computer-readable storage media and program instructions stored on the one or more computer-readable storage media to perform operations. The operations comprise evaluating, by a panel of diverse LLMs, an output from a generative AI system to assess ethics of the output, the output being based on a user prompt. The operations comprise providing, by each LLM of the panel of diverse LLMs, a score indicating a degree of propriety of an ethical issue detected in the output. The operations comprise determining whether the output exceeds an ethics impropriety threshold for ethical acceptability based on the scores from the panel of diverse LLMs. In this way, the computer program product reduces computational overhead associated with manual review and editing of generated outputs, and improves the efficiency of AI output evaluation. The computer program product may conserve processing resources, memory resources, and/or network resources by minimizing the number of iterations required to generate compliant output, reducing the need for manual intervention, and streamlining the output evaluation process. Additionally, the computer program product may optimize the use of LLMs by distributing the evaluation workload across multiple models, thereby reducing the computational load on individual models and improving overall system scalability.

By having multiple LLMs with different perspectives, the computer program product can identify and address potential issues more quickly, reducing the number of iterations required to generate an acceptable output. The diversity of the LLMs can help the computer program product converge on a solution more quickly, reducing the computational resources required to generate an acceptable output. Each LLM may have its own strengths and weaknesses, and by using a diverse panel, the system can be sure to have suitable LLMs evaluate the output. All of this can conserve processing resources, memory, and network bandwidth.

In embodiments, the operations comprise rewriting the prompt to generate a rewritten prompt based on the output and a summary of the ethical issue in a specific domain, the summary being generated by the panel, and outputting the rewritten prompt to the generative AI system.

Generative AI systems, such as those based on LLMs and latent diffusion models (LDMs), have the capability to produce valuable outputs, including text and images, in response to user inputs or prompts. However, while these generated outputs can be correct, there may be an issue with an outputs. For example, a user prompt may request a plan to save money at the grocery store. The output for the prompt may suggest taking groceries out of the store without paying. While not paying for groceries does save money, stealing is unethical. Unethical output or other such issues may pose problems for users and significant risks to providers of such systems, including legal liability, damage to reputation, and alienation of a user base.

Existing approaches to mitigating these risks include non-automated methods like whistleblowing, ethics workflow management, and transparency/disclosure, as well as automated methods such as model training techniques and evaluation tools. However, these methods have limitations, particularly in terms of their ability to effectively evaluate the ethics of generated outputs in real-time and across diverse contexts.

One of the challenges is that the same system that generates the output is also responsible for evaluating its ethics (“fox guarding the henhouse” problem). This can lead to inherent biases and limitations in the evaluation process. Furthermore, the evaluation of ethics in generated outputs is a complex task that requires a broad perspective and the ability to consider multiple viewpoints. Traditional methods of evaluation, which rely on a single system or model, are not sufficient to capture the full range of ethical considerations.

Some implementations described herein provide a computing system that uses a panel of diverse LLMs to evaluate and mitigate improper output in generative AI, including ethically improper output. For example, the system may receive a user prompt (from a human user) and an original output generated by a generative AI system (based on the prompt). The system may provide the output to a panel of LLMs for evaluation. Each LLM of the panel of LLMs may be diverse in that each LLM may have a different architecture, be trained with a different dataset, and/or be from a different vendor. Each LLM of the panel of LLMs may then provide a score indicating a degree of propriety of an ethical issue in the output, and the system may rewrite the prompt based on the scores and the output to generate a rewritten prompt. The panel of LLMs may also provide a summary of the ethical issue for generating the rewritten prompt.

In this way, the system reduces computational overhead associated with manual review and editing of generated outputs, and improves the efficiency of AI output evaluation. The system may conserve processing resources, memory resources, and/or network resources by minimizing the number of iterations required to generate compliant output, reducing the need for manual intervention, and streamlining the output evaluation process. Additionally, the system may optimize the use of LLMs by distributing the evaluation workload across multiple models, thereby reducing the computational load on individual models and improving overall system scalability. The diversity of the LLMs can help the system converge on a solution more quickly, reducing the computational resources required to generate an acceptable output. Each LLM may have its own strengths and weaknesses, and by using a diverse panel, the system can ensure that suitable LLMs evaluate the output. This can conserve processing resources, memory, and network bandwidth. By having a diverse panel of LLMs, the system can automatically identify and address potential issues, reducing the need for manual intervention and conserving human resources. Furthermore, the computing system may avoid unethical output or other outputs with issues that pose significant risks to the users and providers of such systems. As a result, the providers may reduce legal liability, damage to reputation, and alienation of the user base.

In some aspects, the system may perform the rewriting recursively until an ethics impropriety threshold is met or a maximum number of attempts is reached. The system may also report that proper output cannot be generated based on the maximum number of rewrite attempts having been reached.

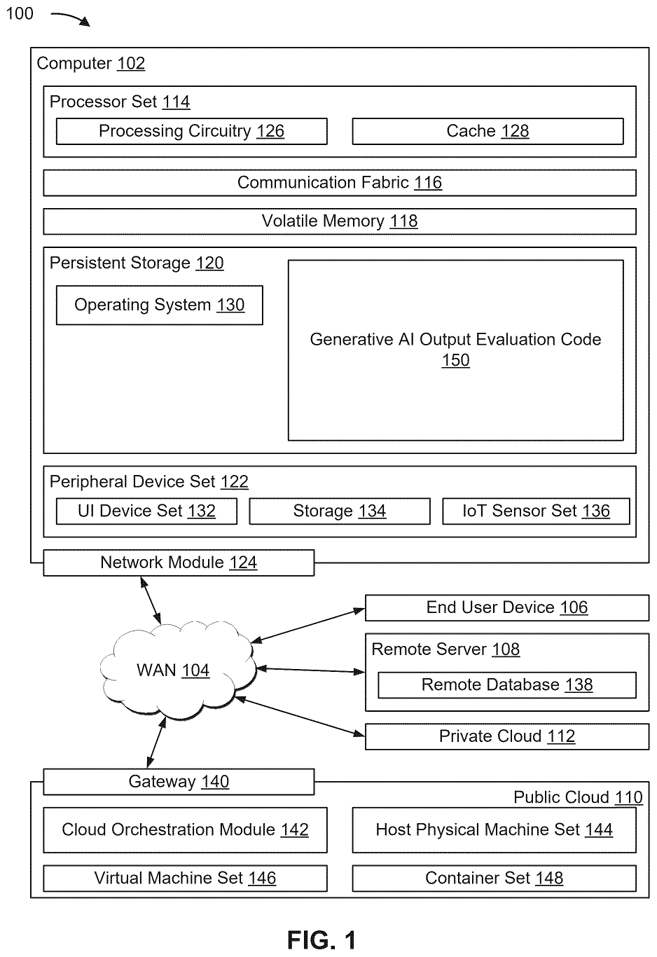

FIG. 1 is a diagram of an example computing environment 100 for evaluating generative AI output using a diverse system described herein.

Computing environment 100 contains an example of an environment for the execution of at least some of the computer code involved in performing the inventive methods, such as generative AI output evaluation code 150. In addition to generative AI output evaluation code 150, computing environment 100 includes, for example, computer 102, wide area network (WAN) 104, end user device (EUD) 106, remote server 108, public cloud 110, and private cloud 112. In this embodiment, computer 102 includes processor set 114 (including processing circuitry 126 and cache 128), communication fabric 116, volatile memory 118, persistent storage 120 (including operating system 130 and generative AI output evaluation code 150, as identified above), peripheral device set 122 (including user interface (UI) device set 132, storage 134, and Internet of Things (IOT) sensor set 136), and network module 124. Remote server 108 includes remote database 138. Public cloud 110 includes gateway 140, cloud orchestration module 142, host physical machine set 144, virtual machine set 146, and container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one or more computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache 128 for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in generative AI output evaluation code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data and re-writing of data. Some familiar forms of persistent storage include magnetic disks and solid state storage devices. Operating system 130 may take any of several forms, such as various known proprietary operating systems or open source Portable Operating System Interface-type operating systems that employ a kernel. The code included in generative AI output evaluation code 150 typically includes at least some of the computer code involved in performing the inventive methods.

Peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers.

End user device (EUD) 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of virtualized computing environments (VCEs) will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 110 and private cloud 112 are both part of a larger hybrid cloud.

Cloud computing services and/or microservices (not separately shown in FIG. 1) may include private and public clouds 110 that are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as-a-service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform-as-a-Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

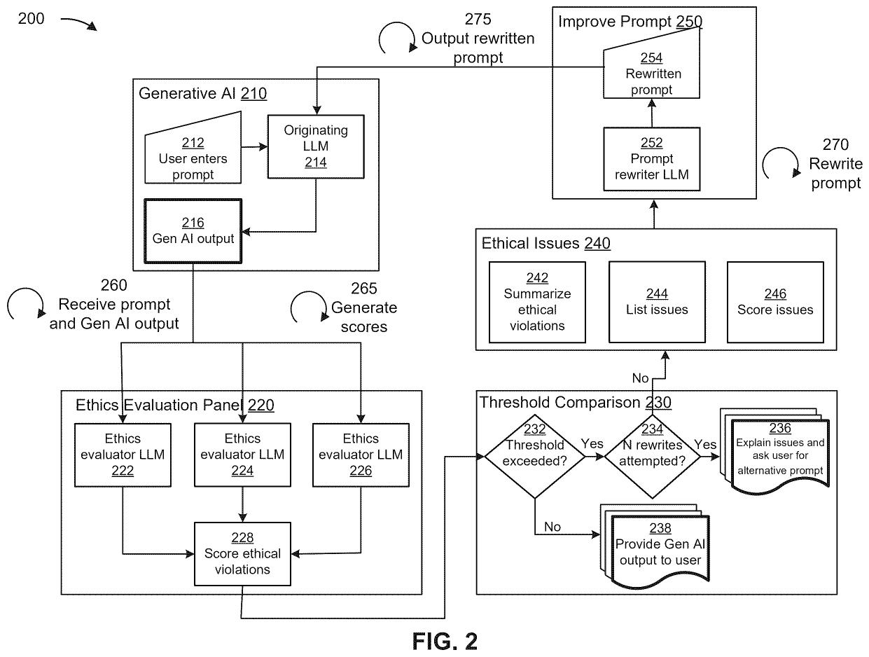

FIG. 2 is a diagram illustrating an example 200 of evaluating and mitigating improper output in generative AI. Example 200 more specifically shows a case of mitigating improper ethical output. A generative AI system 210 (e.g., computer 102) may obtain a user prompt entered by a user (operation 212) and use an originating LLM 214 to generate AI output based on the prompt (operation 216).

The process 200 may begin with a panel of diverse LLMs (e.g., an ethics evaluation panel 220) receiving the prompt and the generative AI output (operation 260). The ethics evaluation panel 220 may include the panel of diverse LLMs (e.g., ethics evaluator LLM 222, ethics evaluator LLM 224, ethics evaluator LLM 226) that are trained to evaluate generative AI output for ethical issues.

The ethics evaluation panel 220 is diverse in that each ethics evaluator LLM has a different architecture and a different training dataset. Each ethics evaluator LLM may be from a different vendor, so as to be wholly different in any bias or approach. Each ethical evaluator LLM may score ethical violations (operation 228). The diversity of the LLMs in the ethics evaluation panel 220 provides a broad perspective and the ability to consider multiple viewpoints, which is beneficial for evaluating ethics in generated outputs. Traditional methods of evaluation, which rely on a single system or model, are not sufficient to capture the full range of ethical considerations. By using a panel of diverse LLMs, the system can ensure that the output is both accurate and ethical. A panel of diverse LLMs reduces the risk of overfitting to a specific dataset or bias, which can occur when a single LLM is used for evaluation. By having multiple LLMs with different architectures and training datasets, the system can capture a wider range of perspectives and identify potential ethical issues that may not be apparent to a single LLM. This can lead to more robust and accurate evaluations and, ultimately, more ethical outputs.

Each ethics evaluator LLM may evaluate the generative AI output and generate a score indicating the degree of propriety of an ethical issue in the generative AI output (operation 265). Degrees of propriety may be judgements made within a defined framework. Each ethics evaluator LLM may associate a score to a degree according to a common rule or set of ranges.

In some implementations, an ethics evaluator LLM may assign a score based on a probability of propriety. The score may correlate to a score in a table of scores. The scores may be an absolute number (e.g., integer, decimal, percentage, fraction), a relative number with respect to a reference number, or a binary score (yes or no).

A threshold comparison component 230 may determine whether the scores of the generative AI output exceed an issue (ethics) impropriety threshold (operation 232). If the threshold is exceeded (output is ethically improper), the system may determine how many prompt rewrites have occurred (operation 234). If a maximum number N of rewrites have occurred, the system may explain the issue to the user and ask the user for an alternative prompt (operation 236). If the threshold has not been met, the system may provide the generative AI output to the user (operation 238).

If the number of rewrites is less than the maximum, an ethical issues component 240 may summarize the ethical violations (operation 242), list issues (operation 244), and/or indicate the scores or score issues (operation 246). The improve prompt component 250 may rewrite the prompt using a prompt rewriter LLM 252 to obtain the rewritten prompt 254 (operation 270). The improve prompt component 250 may output the rewritten prompt (operation 275) to become an input to the originating LLM 214, to generate a new output.

In an example, the original prompt may be, “How can I save money when shopping at the grocery store?” The original output may be, “You can switch the price tags/bar codes of higher priced items with lower priced ones.” The output is ethically improper because it suggests a form of theft.

The ethics evaluation panel 220 evaluates the original output and generates scores indicating the degree of propriety of the ethical issue. For example, ethics evaluator LLM 222 may provide a score of 100% improper, ethics evaluator LLM 224 may provide a score of 75% improper, and ethics evaluator LLM 226 may provide a score of 50% improper. If the original output (e.g., average score) exceeds the issue impropriety threshold (e.g., 30%), the prompt is rewritten by the prompt rewriter LLM 252 based on the scores and the original output to generate a rewritten prompt. For example, the rewritten prompt may be, “How can I save money when shopping at the grocery store while following the law?”

The rewritten prompt is then output to the generative AI system 210, which generates a new output based on the rewritten prompt. The new output is then evaluated by the ethics evaluation panel 220, and the process continues until an acceptable output is generated or a maximum number of attempts is reached.

In this way, ethically improper output of generative AI can be mitigated by rewriting the prompt to avoid an ethical issue and generating a new output based on the rewritten prompt. This process can be repeated multiple times until an acceptable output is generated, ensuring that the output is both accurate and ethical.

In addition, the system may also provide a summary of the ethical issue and the scores generated by the ethics evaluation panel 220. The summary may be used to understand why the original output was deemed ethically improper and how the rewritten prompt was generated. In some implementations, the ethics summary may include a detailed analysis of the ethical issues detected in the original output. This summary may be based on the scores and feedback from each of the ethics evaluator LLMs. The summary may further include a list of the specific ethical issues detected in the original output and a description of the severity of each ethical issue, including the score assigned by each ethics evaluator LLM. The summary may include an explanation of the reasons why each ethical issue was detected, including any relevant context or background information. The summary may include a set of recommendations for how to revise the prompt to avoid or mitigate the detected ethical issues.

The prompt rewriter LLM 252 may use information from the ethics summary, the list of issues, or the scores to generate a rewritten prompt that takes into account the ethical issues detected in the original output. The rewritten prompt is designed to avoid or mitigate these issues, while still conveying the original intent and meaning of the user's query. By providing the ethics summary to the prompt rewriter LLM 252, the system ensures that the rewritten prompt is not only more ethical but also more accurate and informative. This approach enables the system to generate high-quality outputs that are both helpful and responsible.

In an example, if the original prompt was “How can I save money when shopping at the grocery store?” and the ethics evaluation panel detected an issue with bias in the original output, the ethics summary might include a recommendation to revise the prompt to “How can I save money when shopping at the grocery store in a way that is fair and respectful to all individuals?” The prompt rewriter LLM 252 would then use this revised prompt to generate a new output that avoids the detected bias.

In some implementations, the threshold comparison component 230 or the ethical issues component 240 may be configured to allow for user input and feedback. For example, the user may be prompted to provide additional information or clarification on the prompt, or to confirm whether the rewritten prompt is acceptable.

While an ethics issue is discussed for example 200, other issues may include legal issues, religious issues, technical issues, or strategic issues. In another example, the original prompt is, “Write a program to optimize the performance of a computer system” and the original output is a program that is optimized for a specific hardware configuration, but not for others.

This output is improper because it may not be compatible with all hardware configurations. The ethics evaluation panel 220 may evaluate the original output and generate scores indicating the degree of propriety of the technical issue. For example, one evaluator LLM may score the output as 80% improper, while another evaluator LLM may score it as 20% improper. If the original output exceeds the issue impropriety threshold, the prompt is rewritten based on the scores and the original output to generate a rewritten prompt. For example, the rewritten prompt may be, “Write a program to optimize the performance of a computer system for multiple hardware configurations.” The rewritten prompt is then output to the generative AI system, which generates a new output based on the rewritten prompt. This new output is then evaluated by the ethics evaluation panel 220, and the process continues until an acceptable output is generated or a maximum number of attempts is reached. Other technical issues may involve questions of removing encryption or other safeguards to improve the performance of program code. The diversity of evaluator LLMs may result in better outputs for technical issues.

The diversity of the ethics evaluation panel 220 may lead to closer scores among the LLMs. For example, a user may provide a user prompt that asks the generative AI system 210 for advice on how to deal with a difficult coworker. The generative AI system 210 may generate an output that suggests, “try to ignore them and focus on your own work.” Ethics evaluator LLM 222 (trained on a dataset that emphasizes empathy and conflict resolution) may score the output as 60% acceptable, noting that ignoring the coworker might not address the underlying issue. Ethics evaluator LLM 224 (trained on a dataset that prioritizes productivity and efficiency) scores the output as 70% acceptable, reasoning that focusing on one's own work can help to minimize distractions. Ethics evaluator LLM 226 (trained on a dataset that highlights the importance of communication and teamwork) scores the output as 55% acceptable, suggesting that ignoring the coworker could lead to further conflict or misunderstandings.

In this scenario, the diversity of the LLMs' perspectives and training data allows the system to capture a range of potential issues with the output. While the scores are close, they are not identical, and the system can use this diversity to determine that the output may not be entirely appropriate. For example, the system could use a threshold of 65% acceptability to determine whether the output is suitable. In this case, the output would not meet the threshold, and the system could rewrite the prompt to generate a new output that takes into account the concerns raised by the ethics evaluation panel 220. The rewritten prompt might ask the generative AI system to provide advice on how to address the underlying issue with the coworker, rather than simply ignoring them. This could lead to a more constructive and effective solution, thanks to the diversity of perspectives provided by the ethics evaluation panel 220. The threshold may be set to account for closer scores and to obtain more precision with target expectations.

In another example, a user prompt may ask the generative AI system 210 for advice on how to optimize the hiring process for a new job opening. The generative AI system 210 may generate an output that suggests to “use AI-powered tools to analyze the social media profiles of job applicants to assess their personality and character.” In this case, the ethics evaluation panel 220 may evaluate the output and generate scores that are pretty close, but not identical. For example, ethics evaluator LLM 222 (trained on a dataset that emphasizes efficiency and cost-effectiveness) scores the output as 75% acceptable, noting that the approach could save time and resources in the hiring process. Ethics evaluator LLM 224 (trained on a dataset that prioritizes fairness and non-discrimination) scores the output as 50% acceptable, raising concerns that the AI-powered tools could perpetuate biases and discriminate against certain groups of applicants. Ethics evaluator LLM 226 (trained on a dataset that highlights the importance of transparency and explainability in AI decision-making) scores the output as 65% acceptable, suggesting that the AI-powered tools may lack transparency in their decision-making processes and could be difficult to explain to applicants.

In this scenario, the diversity of the LLMs' perspectives and training data allows the system to capture a range of potential ethics issues with the output. While the scores are close, they are not identical, and the system can use this diversity to determine that the output may not be entirely ethical. For example, the system could use a threshold of 70% acceptability to determine whether the output is suitable. In this case, the output would not meet the threshold, and the system could rewrite the prompt to generate a new output that takes into account the ethics concerns raised by the ethic evaluation panel 220.

In an example of a mix of legal and ethical issues, a user prompt for how to get a friend to the hospital as soon as possible in an emergency may result in an original generative AI output that suggests driving faster than the speed limit in an emergency. The diversity of the evaluator LLMs may reach different scores and lead to more appropriate outputs. Evaluator LLMs may score issues that may involve subjects where it is questioned whether the ends justify the means. Examples of religious issues may involve accommodating religious practices or addressing contradicting religious practices.

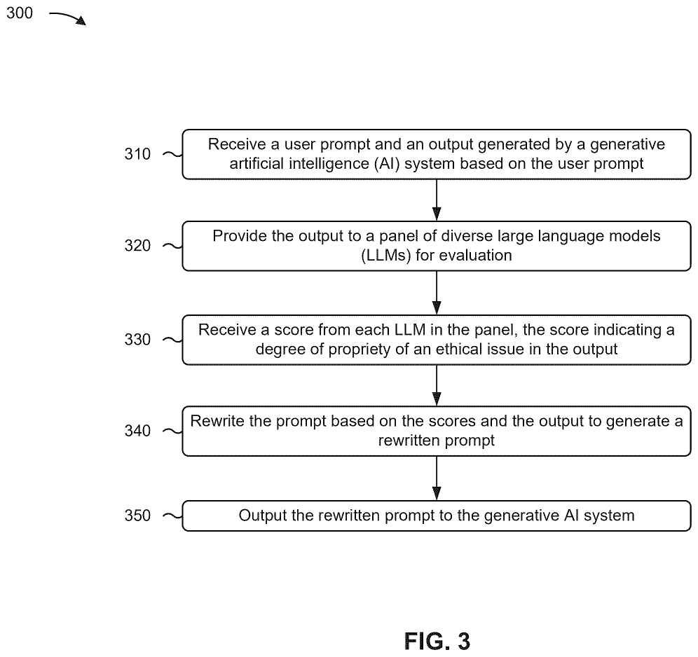

FIG. 3 is a flowchart of an example process 300 associated with evaluating generative AI output using diverse systems. In some implementations, one or more process blocks of FIG. 3 are performed by a device (e.g., computer 102). In some implementations, one or more process blocks of FIG. 3 are performed by another device or a group of devices separate from or including the device. Additionally, or alternatively, one or more process blocks of FIG. 3 may be performed by one or more components of computer 102, such as processor set 114, volatile memory 118, persistent storage 120, or network module 124.

As shown in FIG. 3, process 300 may include receiving a user prompt and an output generated by a generative AI system based on the user prompt (block 310). For example, the device may receive a user prompt and an output generated by a generative AI system based on the user prompt, as described above.

As further shown in FIG. 3, process 300 may include providing the output to a panel of diverse LLMs (e.g., ethics evaluation panel 220) for evaluation (block 320). For example, the device may provide the output to a panel of diverse LLMs for evaluation, as described above.

As further shown in FIG. 3, process 300 may include receiving a score from each LLM of the panel of diverse LLMs, the score indicating a degree of propriety of an ethical issue in the output (block 330). For example, the device may receive a score from each LLM of the panel of diverse LLMs, the score indicating a degree of propriety of an ethical issue in the output, as described above.

As further shown in FIG. 3, process 300 may include rewriting the prompt based on the scores and the output to generate a rewritten prompt (block 340). For example, the device may rewrite the prompt based on the scores and the output to generate a rewritten prompt, as described above.

As further shown in FIG. 3, process 300 may include outputting the rewritten prompt to the generative AI system (block 350). For example, the device may output the rewritten prompt to the generative AI system, as described above.

Process 300 may include additional implementations, such as any single implementation or any combination of implementations described below and/or in connection with one or more other processes described elsewhere herein.

In a first implementation, the generative AI system and each LLM of the panel of diverse LLMs are associated with a different vendor and architecture.

In a second implementation, alone or in combination with the first implementation, the LLMs of the panel of diverse LLMs are trained on different datasets.

In a third implementation, alone or in combination with one or more of the first and second implementations, each LLM of the panel of diverse LLMs is trained specifically to evaluate ethics of a generative AI output.

In a fourth implementation, alone or in combination with one or more of the first through third implementations, the panel of diverse LLMs is isolated from the generative AI system to prevent bias.

In a fifth implementation, alone or in combination with one or more of the first through fourth implementations, the score from each LLM of the panel of diverse LLMs is weighted based on one or more LLM factors.

In a sixth implementation, alone or in combination with one or more of the first through fifth implementations, the rewriting of the prompt comprises rewriting the prompt to avoid the ethical issue.

In a seventh implementation, alone or in combination with one or more of the first through sixth implementations, the rewriting of the prompt includes rewriting the prompt a plurality of times until the degree of propriety is met or a threshold is reached.

In an eighth implementation, alone or in combination with one or more of the first through seventh implementations, the panel of diverse LLMs provides a summary of the ethical issue.

In a ninth implementation, alone or in combination with one or more of the first through eighth implementations, the rewriting of the prompt includes rewriting the prompt based on the summary of the ethical issue.

In a tenth implementation, alone or in combination with one or more of the first through ninth implementations, process 300 includes receiving a new output from the generative AI system based on the rewritten prompt, providing the new output to the panel of diverse LLMs for evaluation, and receiving a new score from each LLM in the panel of diverse LLMs, the new score indicating whether there is an ethical issue in the new output.

Although FIG. 3 shows example blocks of process 300, in some implementations, process 300 includes additional blocks, fewer blocks, different blocks, or differently arranged blocks than those depicted in FIG. 3. Additionally, or alternatively, two or more of the blocks of process 300 may be performed in parallel.

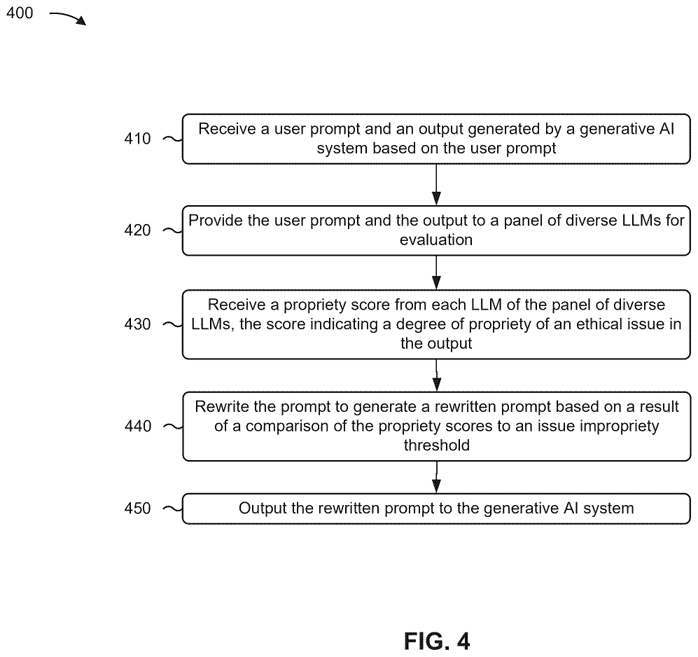

FIG. 4 is a flowchart of an example process 400 associated with evaluating generative AI output using diverse LLMs. In some implementations, one or more process blocks of FIG. 4 are performed by a device (e.g., computer 102). In some implementations, one or more process blocks of FIG. 4 are performed by another device or a group of devices separate from or including the device. Additionally, or alternatively, one or more process blocks of FIG. 4 may be performed by one or more components of computer 102, such as processor set 114, volatile memory 118, persistent storage 120, or network module 124.

As shown in FIG. 4, process 400 may include receiving a user prompt and an output from a generative AI system based on the user prompt (block 410). For example, the device may receive a user prompt and an output from a generative AI system based on the user prompt, as described above.

As further shown in FIG. 4, process 400 may include providing the prompt and the output to a panel of diverse LLMs (e.g., ethics evaluation panel 220) for evaluation (block 420). For example, the device may provide the prompt and the output to a panel of diverse LLMs for evaluation, as described above.

As further shown in FIG. 4, process 400 may include receiving a propriety score from each LLM of the panel of diverse LLMs, where the propriety scores are weighted differently for each LLM (block 430). For example, the device may receive a propriety score from each LLM of the panel of diverse LLMs, where the propriety scores are weighted differently for each LLM, as described above.

As further shown in FIG. 4, process 400 may include rewriting the prompt to generate a rewritten prompt based on a result of a comparison of the propriety scores to an issue impropriety threshold (block 440). For example, the device may rewrite the prompt to generate a rewritten prompt based on a result of a comparison of the propriety scores to an issue impropriety threshold, as described above.

As further shown in FIG. 4, process 400 may include outputting the rewritten prompt to the generative AI system (block 450). For example, the device may output the rewritten prompt to the generative AI system, as described above.

Process 400 may include additional implementations, such as any single implementation or any combination of implementations described below and/or in connection with one or more other processes described elsewhere herein.

In a first implementation, the issue impropriety threshold is an ethics impropriety threshold.

In a second implementation, alone or in combination with the first implementation, the issue impropriety threshold is a legal impropriety threshold.

In a third implementation, alone or in combination with one or more of the first and second implementations, the issue impropriety threshold is a religious impropriety threshold.

In a fourth implementation, alone or in combination with one or more of the first through third implementations, the panel of diverse LLMs includes LLMs from different vendors and that have different architectures and training datasets.

In a fifth implementation, alone or in combination with one or more of the first through fourth implementations, process 400 includes performing the rewriting recursively until the issue impropriety threshold is met or a maximum number of attempts is reached.

In a sixth implementation, alone or in combination with one or more of the first through fifth implementations, process 400 includes reporting that proper output cannot be generated based on the maximum number of rewrite attempts having been reached.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

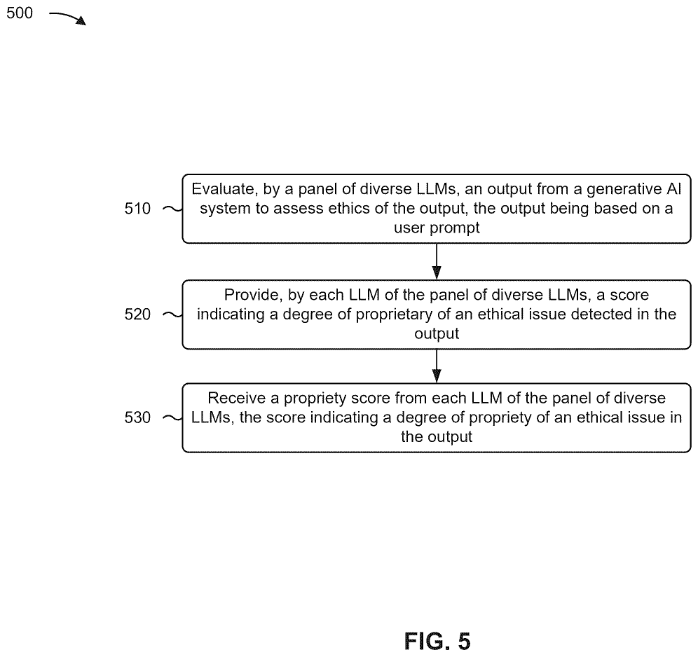

FIG. 5 is a flowchart of an example process 500 associated with evaluating generative AI output using diverse LLMs. In some implementations, one or more process blocks of FIG. 5 are performed by a device (e.g., computer 102). In some implementations, one or more process blocks of FIG. 5 are performed by another device or a group of devices separate from or including the device. Additionally, or alternatively, one or more process blocks of FIG. 5 may be performed by one or more components of computer 102, such as processor set 114, volatile memory 118, persistent storage 120, or network module 124.

As shown in FIG. 5, process 500 may include evaluating, by a panel of diverse LLMs (e.g., ethics evaluation panel 220) an output from a generative AI system to assess ethics of the output, the output being based on a user prompt (block 510). For example, the device may evaluate, by a panel of diverse LLMs, an output from a generative AI system to assess ethics of the output, the output being based on a user prompt, as described above.

As further shown in FIG. 5, process 500 may include providing, by each LLM of the panel of diverse LLMs, a score indicating a degree of propriety of an ethical issue detected in the output (block 520). For example, the device may provide, by each LLM of the panel of diverse LLMs, a score indicating a degree of propriety of an ethical issue detected in the output, as described above.

As further shown in FIG. 5, process 500 may include determining whether the output exceeds an ethics impropriety threshold for ethical acceptability based on the scores from the panel of diverse LLMs (block 530). For example, the device may determine whether the output exceeds an ethics impropriety threshold for ethical acceptability based on the scores from the panel of diverse LLMs, as described above.

Process 500 may include additional implementations, such as any single implementation or any combination of implementations described below and/or in connection with one or more other processes described elsewhere herein.

In a first implementation, process 500 includes rewriting the prompt to generate a rewritten prompt based on the output and a summary of the ethical issue in a specific domain, the summary being generated by the panel, and outputting the rewritten prompt to the generative AI system.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A computer-implemented method, comprising:
receiving, by a processor set, a user prompt and an output generated by a generative artificial intelligence (AI) system based on the user prompt;
providing, by the processor set, the output to a panel of diverse large language models (LLMs) for evaluation, wherein the panel of diverse LLMs comprises LLMs having different architectures and different training datasets;
receiving, by the processor set, a score from each LLM of the panel of diverse LLMs, the score indicating a degree of propriety of an ethical issue in the output;
rewriting, by the processor set, the prompt based on the scores and the output to generate a rewritten prompt; and
outputting, by the processor set, the rewritten prompt to the generative AI system.

2. The computer-implemented method of claim 1, wherein the generative AI system and each LLM of the panel of diverse LLMs are associated with a different vendor and architecture.

3. The computer-implemented method of claim 2, wherein the LLMs of the panel of diverse LLMs are trained on different datasets.

4. The computer-implemented method of claim 3, wherein each LLM of the panel of diverse LLMs is trained specifically to evaluate ethics of a generative AI output.

5. The computer-implemented method of claim 3, wherein the panel of diverse LLMs is isolated from the generative AI system to prevent bias.

6. The computer-implemented method of claim 1, wherein the score from each LLM of the panel of diverse LLMs is weighted based on one or more LLM factors.

7. The computer-implemented method of claim 1, wherein the rewriting of the prompt comprises rewriting the prompt to avoid the ethical issue.

8. The computer-implemented method of claim 1, wherein the rewriting of the prompt includes rewriting the prompt a plurality of times until the degree of propriety is met or a threshold is reached.

9. The computer-implemented method of claim 1, wherein the panel of diverse LLMs provides a summary of the ethical issue.

10. The computer-implemented method of claim 9, wherein the rewriting of the prompt includes rewriting the prompt based on the summary of the ethical issue.

11. The computer-implemented method of claim 1, further comprising:
receiving a new output from the generative AI system based on the rewritten prompt;
providing the new output to the panel of diverse LLMs for evaluation; and
receiving a new score from each LLM in the panel of diverse LLMs, the new score indicating whether there is an ethical issue in the new output.

12. A computer system, comprising:
a processor set;
one or more computer-readable storage media; and
program instructions stored on the one or more computer-readable storage media to cause the processor set to perform operations comprising:
receiving a user prompt and an output from a generative artificial intelligence (AI) system based on the user prompt;
providing the prompt and the output to a panel of diverse large language models (LLMs) for evaluation, wherein the panel of diverse LLMs comprises LLMs having different architectures and different training datasets;
receiving a propriety score from each LLM of the panel of diverse LLMs, wherein the propriety scores are weighted differently for each LLM;
rewriting the prompt to generate a rewritten prompt based on a result of a comparison of the propriety scores to an issue impropriety threshold; and
outputting the rewritten prompt to the generative AI system.

13. The computer system of claim 12, wherein the issue impropriety threshold is an ethics impropriety threshold.

14. The computer system of claim 12, wherein the issue impropriety threshold is a legal impropriety threshold.

15. The computer system of claim 12, wherein the issue impropriety threshold is a religious impropriety threshold.

16. The computer system of claim 12, wherein the panel of diverse LLMs includes LLMs from different vendors and that have different architectures and training datasets.

17. The computer system of claim 12, wherein the operations comprise performing the rewriting recursively until the issue impropriety threshold is met or a maximum number of attempts is reached.

18. The computer system of claim 17, wherein the operations comprise reporting that proper output cannot be generated based on the maximum number of rewrite attempts having been reached.

19. A computer program product, comprising:
one or more computer-readable storage media; and
program instructions stored on the one or more computer-readable storage media to perform operations comprising:
evaluating, by a panel of diverse large language models (LLMs), an output from a generative artificial intelligence (AI) system to assess ethics of the output, wherein the output is based on a user prompt, and wherein the panel of diverse LLMs comprises LLMs having different architectures and different training datasets;
providing, by each LLM of the panel of diverse LLMs, a score indicating a degree of propriety of an ethical issue detected in the output; and
determining whether the output exceeds an ethics impropriety threshold for ethical acceptability based on the scores from the panel of diverse LLMs.

20. The computer program product of claim 19, wherein the operations comprise:
rewriting the prompt to generate a rewritten prompt based on the output and a summary of the ethical issue in a specific domain, the summary being generated by the panel; and
outputting the rewritten prompt to the generative AI system.
